(19) United States
(12) Patent Application Publication
(10) Pub. No.: US 2007/0203651 A1
(43) Pub. Date: Aug. 30, 2007

(54) Magnetic measurements while rotating

(75) Inventors: Martin Blanz, Celle (DE); Andy Brooks, Tomball, TX (US)

Correspondence Address: MADAN, MOSSMAN & SRIRAM, P.C., 2603 AUGUSTA, SUITE 700, HOUSTON, TX, 77057, US

(73) Assignee: Baker Hughes Incorporated

(21) Appl. No.: 11/256,794

(22) Filed: Oct. 24, 2005

Related U.S. Application Data
(60) Provisional application No. 60/621,259, filed on Oct. 22, 2004.
(60) Provisional application No. 60/633,238, filed on Dec. 3, 2004.

(51) Int. Cl. G06F 19/00

(52) U.S. Cl. 702/6

(57) ABSTRACT

Measurements made using at least one two-component magnetometers on a rotating bottomhole assembly are processed to correct for disturbance of the magnetic field due to the rotating drillstring and get an estimate of instantaneous toolface angle.

### CROSS-REFERENCES TO RELATED APPLICATIONS

This application claims priority from U.S. Provisional Patent Application Ser. No. 60/621,259 filed on Oct. 22, 2004 and from U.S. Provisional Patent Application Ser. No. 60/633,238 filed on Dec. 3, 3004.

### BACKGROUND OF THE INVENTION

1. Field of the Invention

The invention relates to the field of borehole measurement. More particularly, the present invention relates to correcting magnetic field measurements obtained in a drillstring rotating in the earth's magnetic field.

2. Description of the Related Art

Oil well logging has been known for many years and provides an oil and gas well driller with information about the particular earth formation being drilled. In conventional oil well logging, after a well has been drilled, a probe known as a sonde is lowered into the borehole and used to determine some characteristic of the formations which the well has traversed. The probe is typically a hermetically sealed steel cylinder which hangs at the end of a long cable which gives mechanical support to the sonde and provides power to the instrumentation inside the sonde. The cable also provides communication channels for sending information up to the surface. It thus becomes possible to measure some parameter of the earth's formations as a function of depth, that is, while the sonde is being pulled uphole. Such “wireline” measurements are normally done in real time (however, these measurements are taken long after the actual drilling has taken place).

Measurement-while-drilling logging either partly or totally eliminates the necessity of interrupting the drilling operation to remove the drillstring from the hole in order to make the necessary measurements by wireline techniques. In addition to the ability to log the characteristics of the formation through which the drill bit is passing, this information on a real time basis provides substantial safety advantages for the drilling operation.

One potential problem with MWD logging tools is that the measurements are typically made while the tool is rotating. Since the measurements are made shortly after the drillbit has drilled the borehole, washouts are less of a problem than in wireline logging. Nevertheless, there can be some variations in the spacing between the logging tool and the borehole wall (“standoff”) with azimuth. Nuclear measurements are particularly degraded by large standoffs due to the scattering produced by borehole fluids between the tool and the formation.

There are several teachings in prior art that involve partitioning a cross-section of the borehole into a number of sectors. For example, U.S. Pat. No. 5,397,893 to Minette, teaches a method for analyzing data from a measurement-while-drilling (MWD) formation evaluation logging tool which compensates for rotation of the logging tool (along with the rest of the drillstring) during measurement periods. U.S. Pat. No. 5,513,528 to Holenka et al. teaches a method and apparatus for measuring formation characteristics as a function of azimuth about the borehole. The measurement apparatus includes a logging while drilling tool which turns in the borehole while drilling. The down vector of the tool is derived first by determining an angle φ between a vector to the earth's north magnetic pole, as referenced to the cross sectional plane of a measuring while drilling (MWD) tool and a gravity down vector as referenced in said plane. The logging while drilling (LWD) tool includes magnetometers and accelerometers placed orthogonally in a cross-sectional plane. Using the magnetometers and/or accelerometer measurements, the toolface angle can usually be determined. The angle φ is transmitted to the logging while drilling tool thereby allowing a continuous determination of the gravity down position in the logging while drilling tool. Quadrants, that is, angular distance segments, are measured from the down vector.

Neither Minette, nor Holenka address possible sources of error in relying on magnetometer readings made using magnetometers on a rotating drillstring. There are prior art methods that address the problem of correction of errors caused by metallic drill collars, casing, and accumulated debris. However, the effect on magnetometer readings due to the rotation of the drillstring itself have not been addressed.

It is well known that eddy currents are generated in an electrically conducting Bottom Hole Assembly (BHA), rotating in the earth's magnetic field. These eddy currents generate their own magnetic field. As a consequence, the earth's magnetic field, as measured by magnetic sensors in the BHA during rotation, is not the same as the earth's magnetic field measurement by magnetic sensors at rest. The magnetic field is altered in both magnitude and direction if the BHA rotates and if the axis of the BHA is not aligned along the earth's field, i.e. if the earth's field has a component orthogonal to the BHA axis.

The effect on magnetic toolface is discussed in U.S. Pat. No. 5,012,412, to Helm. Helm shows that the effect of a rotating magnetic toolface can be seen as a shift φ in toolface angle:

$$φ = {tan}^{- 1} [ \frac{ω \cdot σ \cdot μ \cdot ( {D}^{2} - {d}^{2} )}{16} ] , \qquad ( 1 )$$

where ω=angular velocity (rad/s), σ=electrical conductivity (S/m), μ=magnetic permeability (h/m), and D and d are the collar OD and ID (m). Helm also estimates a corresponding reduction in the transverse field component,
B_{xy,meas}=B_{xy,true}·|cos φ| (2)
although it is not certain that this formula was intended for use with large values of φ.

Such effects may be significant when measuring instantaneous toolface angle for binning azimuthal formation measurements, or when determining the borehole azimuth while rotating using the xy magnetometers.

The rotation of the borehole assembly by nature affects the measured value of the surrounding earth's magnetic field. There is a need for a method of correcting these measured values in order determine accurate orientation using measurements made by a magnetometer on a MWD logging tool. The present invention satisfies this need.

### SUMMARY OF THE INVENTION

The present invention is a method of and an apparatus for determining a toolface angle of a rotating bottom hole assembly (BHA) in a borehole in an earth formation, wherein rotation of BHA producing a disturbance of the earth's magnetic field. Two components of the earth's magnetic field are measured at least one azimuthal position on the rotating BHA. Processing of these measurements gives an estimate of the toolface angle. The processing may include first determining the earth's magnetic field components in a fixed coordinate frame. The estimated values in the fixed coordinate frame can be further processed to get an estimate of the undisturbed earth's magnetic field. The estimates of the undisturbed field components can then be used to give the instantaneous toolface angle. In one embodiment of the invention, the magnetic field measurements may be made using one or more two component magnetometers on the outer surface of the BHA.

The processing of the measurements may be made by a downhole processor. Necessary instructions for the processing may be implemented on a suitable machine readable memory device downhole.

### BRIEF DESCRIPTION OF THE DRAWINGS

For detailed understanding of the present invention, references should be made to the following detailed description of the preferred embodiment, taken in conjunction with the accompanying drawings, in which like elements have been given like numerals and wherein:

FIG. 1 is a schematic illustration of a drilling system used in the present invention;

FIG. 2 shows a variation of transverse magnetic field recorded by a magnetometer placed outside an Aluminum collar.

FIG. 3 shows a variation of toolface angle by a magnetometer placed outside an Aluminum collar.

FIGS. 4-5 shows variations of transverse magnetic field and toolface angle, respectively, recorded by a magnetometer placed inside an Aluminum collar.

FIG. 6 shows magnetic field strength plotted against collar rpm.

FIG. 7 shows magnetic toolface plotted against collar rpm

FIG. 8 shows an FE model of a background magnetic field and a hollow cylinder.

FIG. 9 is a closer look on the FE model of FIG. 8.

FIG. 10 shows magnetic field lines of a complete model of a rotating Aluminum collar.

FIG. 11 shows a contour plot of the magnitude of the flux density B of FIG. 10.

FIG. 12 shows field lines of a model for a rotating Monel collar.

FIG. 13 shows a contour plot of the magnitude of the flux density B of FIG. 12.

FIGS. 14-15 show plots of the Bₓ and B_{y} components, respectively, at the circumference of the BHA rotating at 300 rpm for a Monel collar;

FIGS. 16-17 show plots of the Bₓ and B_{y} components, respectively, at the circumference of the BHA rotating at 300 rpm for an Aluminum collar;

FIG. 18 shows the modulus of the magnetic flux along the circumference of the BHA rotating at 300 rpm for a Monel collar; and

FIG. 19 illustrates field components related to the use of two two-component magnetometers on a rotating BHA.

### DETAILED DESCRIPTION OF THE INVENTION

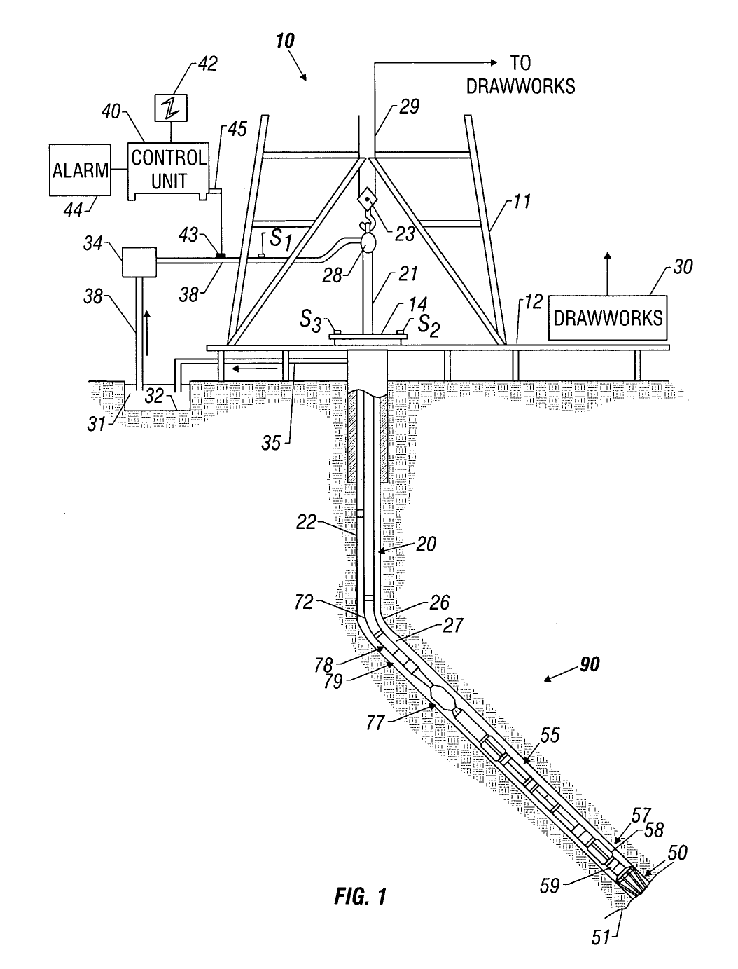

FIG. 1 shows a schematic diagram of a drilling system 10 with a drillstring 20 carrying a drilling assembly 90 (also referred to as the bottom hole assembly, or “BHA”) conveyed in a “wellbore” or “borehole” 26 for drilling the wellbore. The drilling system 10 includes a conventional derrick 11 erected on a floor 12 which supports a rotary table 14 that is rotated by a prime mover such as an electric motor (not shown) at a desired rotational speed. The drillstring 20 includes a tubing such as a drill pipe 22 or a coiled-tubing extending downward from the surface into the borehole 26. The drillstring 20 is pushed into the wellbore 26 when a drill pipe 22 is used as the tubing. For coiled-tubing applications, a tubing injector, such as an injector (not shown), however, is used to move the tubing from a source thereof, such as a reel (not shown), to the wellbore 26. The drill bit 50 attached to the end of the drillstring breaks up the geological formations when it is rotated to drill the borehole 26. If a drill pipe 22 is used, the drillstring 20 is coupled to a drawworks 30 via a Kelly joint 21, swivel 28, and line 29 through a pulley 23. During drilling operations, the drawworks 30 is operated to control the weight on bit, which is an important parameter that affects the rate of penetration. The operation of the drawworks is well known in the art and is thus not described in detail herein.

During drilling operations, a suitable drilling fluid 31 from a mud pit (source) 32 is circulated under pressure through a channel in the drillstring 20 by a mud pump 34. The drilling fluid passes from the mud pump 34 into the drillstring 20 via a desurger (not shown), fluid line 38 and Kelly joint 21. The drilling fluid 31 is discharged at the borehole bottom 51 through an opening in the drill bit 50. The drilling fluid 31 circulates uphole through the annular space 27 between the drillstring 20 and the borehole 26 and returns to the mud pit 32 via a return line 35. The drilling fluid acts to lubricate the drill bit 50 and to carry borehole cutting or chips away from the drill bit 50. A sensor S₁ typically placed in the line 38 provides information about the fluid flow rate. A surface torque sensor S₂ and a sensor S₃ associated with the drillstring 20 respectively provide information about the torque and rotational speed of the drillstring. Additionally, a sensor (not shown) associated with line 29 is used to provide the hook load of the drillstring 20.

In one embodiment of the invention, the drill bit 50 is rotated by only rotating the drill pipe 22. In another embodiment of the invention, a downhole motor 55 (mud motor) is disposed in the drilling assembly 90 to rotate the drill bit 50 and the drill pipe 22 is rotated usually to supplement the rotational power, if required, and to effect changes in the drilling direction.

In an exemplary embodiment of FIG. 1, the mud motor 55 is coupled to the drill bit 50 via a drive shaft (not shown) disposed in a bearing assembly 57. The mud motor rotates the drill bit 50 when the drilling fluid 31 passes through the mud motor 55 under pressure. The bearing assembly 57 supports the radial and axial forces of the drill bit. A stabilizer 58 coupled to the bearing assembly 57 acts as a centralizer for the lowermost portion of the mud motor assembly.

In one embodiment of the invention, a drilling sensor module 59 is placed near the drill bit 50. The drilling sensor module contains sensors, circuitry and processing software and algorithms relating to the dynamic drilling parameters. Such parameters typically include bit bounce, stick-slip of the drilling assembly, backward rotation, torque, shocks, borehole and annulus pressure, acceleration measurements and other measurements of the drill bit condition. A suitable telemetry or communication sub 72 using, for example, two-way telemetry, is also provided as illustrated in the drilling assembly 90. The drilling sensor module processes the sensor information and transmits it to the surface control unit 40 via the telemetry system 72.

The communication sub 72, a power unit 78 and an MWD tool 79 are all connected in tandem with the drillstring 20. Flex subs, for example, are used in connecting the MWD tool 79 in the drilling assembly 90. Such subs and tools form the bottom hole drilling assembly 90 between the drillstring 20 and the drill bit 50. The drilling assembly 90 makes various measurements including the pulsed nuclear magnetic resonance measurements while the borehole 26 is being drilled. The communication sub 72 obtains the signals and measurements and transfers the signals, using two-way telemetry, for example, to be processed on the surface. Alternatively, the signals can be processed using a downhole processor in the drilling assembly 90.

The surface control unit or processor 40 also receives signals from other downhole sensors and devices and signals from sensors S₁—S₃ and other sensors used in the system 10 and processes such signals according to programmed instructions provided to the surface control unit 40. The surface control unit 40 displays desired drilling parameters and other information on a display/monitor 42 utilized by an operator to control the drilling operations. The surface control unit 40 typically includes a computer or a microprocessor-based processing system, memory for storing programs or models and data, a recorder for recording data, and other peripherals. The control unit 40 is typically adapted to activate alarms 44 when certain unsafe or undesirable operating conditions occur. The system also includes a downhole processor, sensor assembly for making formation evaluation and an orientation sensor. These may be located at any suitable position on the bottom hole assembly (BHA).

One embodiment of the present invention uses the ORD-AZ test apparatus of U.S. patent application Ser. No. 10/771,675, of Estes et al., the content of which is incorporated herein by reference as part of the BHA. The ORD-AZ apparatus is used to demonstrate measurement of toolface angle using magnetometers. The ORD-AZ apparatus comprises a short Aluminum collar section having a 7″ OD and 2″ ID driven by a variable speed electric motor via a flexible coupling. An optical sensor records each revolution by identification of a single optical mark placed on the collar. All data is recorded.

The test collar is oriented approximately horizontal and east-west. In a first test run, a magnetometer is placed about 12 inches outside the test collar. For a second run, the magnetometer is placed about 6 inches inside. A fixture is employed to mount the magnetometer inside the test collar. In both runs, the z-axis of the magnetometer is aligned approximately with the rotation axis of the collar.

For both runs, the motor speed increases in steps to its maximum then is decreased in steps. Due to wind-up in the flexible drive shaft, the rotation speed of the collar is not a constant. Speed variations that occur within a given revolution are not identifiable through detection of the single optical mark, which responds once per revolution.

Data from a DAT recorder are decimated to 100 samples per second. Toolface angle is computed as the arctangent of the ratio of x and y magnetometer measurements. RPM is calculated for each revolution of the test piece, determined from the time between successive threshold value crossings of the optical sensor output.

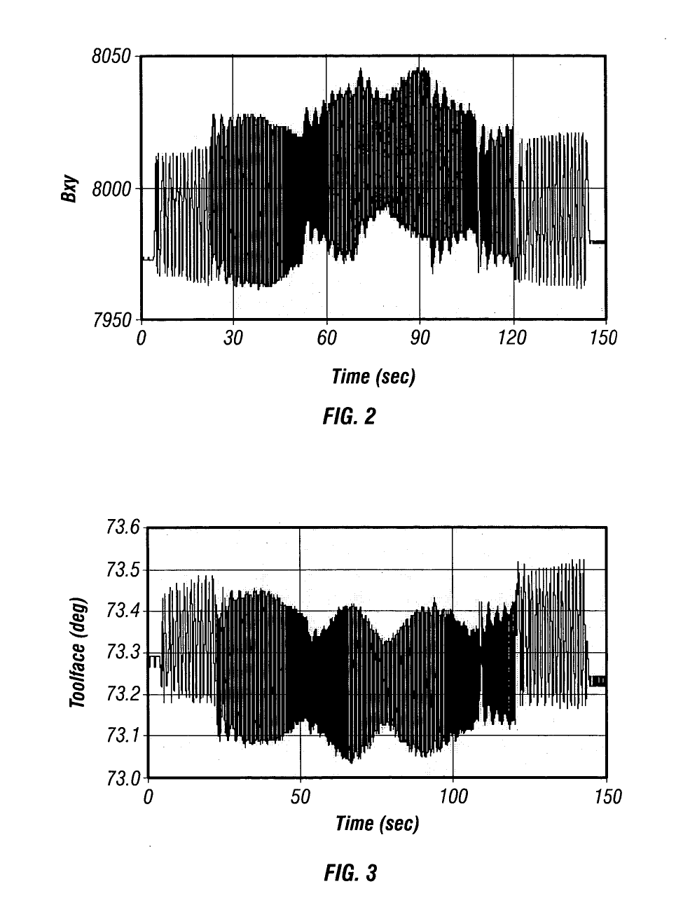

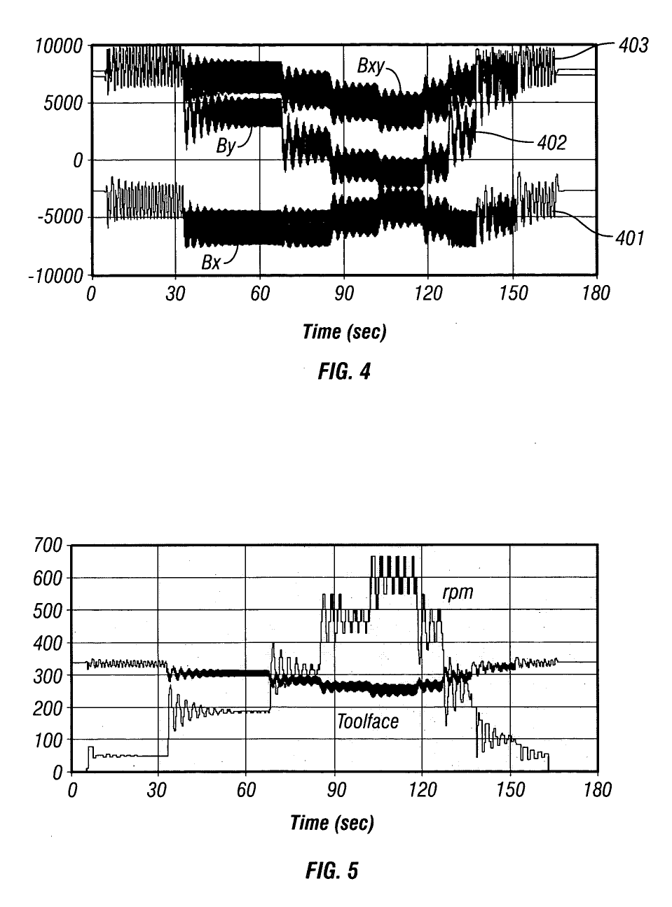

FIG. 2 shows variation of the transverse magnetic field during the first run, where the magnetometer is placed outside the collar. Time is shown in seconds along the abscissa, and magnetic field strength is shown along the ordinate. FIG. 3 shows the observed variation of the toolface angle corresponding to the rotational speed. Time is shown in seconds along the abscissa, and toolface angle is shown in degrees along the ordinate. As can be seen, the variations in both FIGS. 2 and 3 are slight. Magnetic toolface angle varies by less than 0.5 degrees, and the transverse or xy field intensity varies by about 1 percent. The variation between values obtained from one selected revolution speed to another is generally less than the variation in the range of values which occur at a single rotary speed. These data indicate that at a distance of about 12 inches beyond the end of the collar, the fields due to eddy currents have a very small effect on the measured earth's magnetic field.

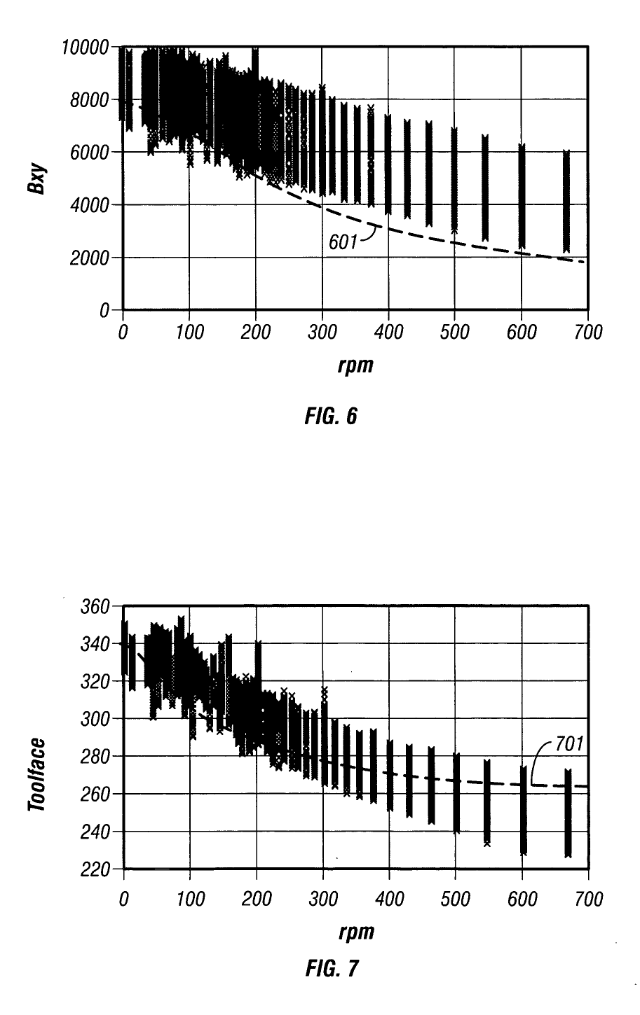

FIGS. 4 and 5 show results from a similar run, but with the magnetometer placed inside the Aluminum collar. Here the shifts in toolface angle and xy field strength are more dramatic. FIGS. 4 and 5 show systematic decreases in B_{xy} and toolface angle, as collar rpm is increased. FIG. 4 shows Bₓ (401), B_{y} (402), and vector sum B_{xy} (403). Corresponding collar speed is shown in FIG. 5. Time is shown in seconds along the abscissa and magnetic field strength is shown is degrees along the ordinate. FIG. 5 shows toolface angle (501) and collar rpm (502). Time is shown in seconds along the abscissa. The plot of rpm versus time in FIG. 5 shows surges in rpm having a period of about 2.5 seconds. However significant variations in rpm within each revolution can account for the variation in response even at apparently steady rpm, as seen at times 30 or 60 seconds.

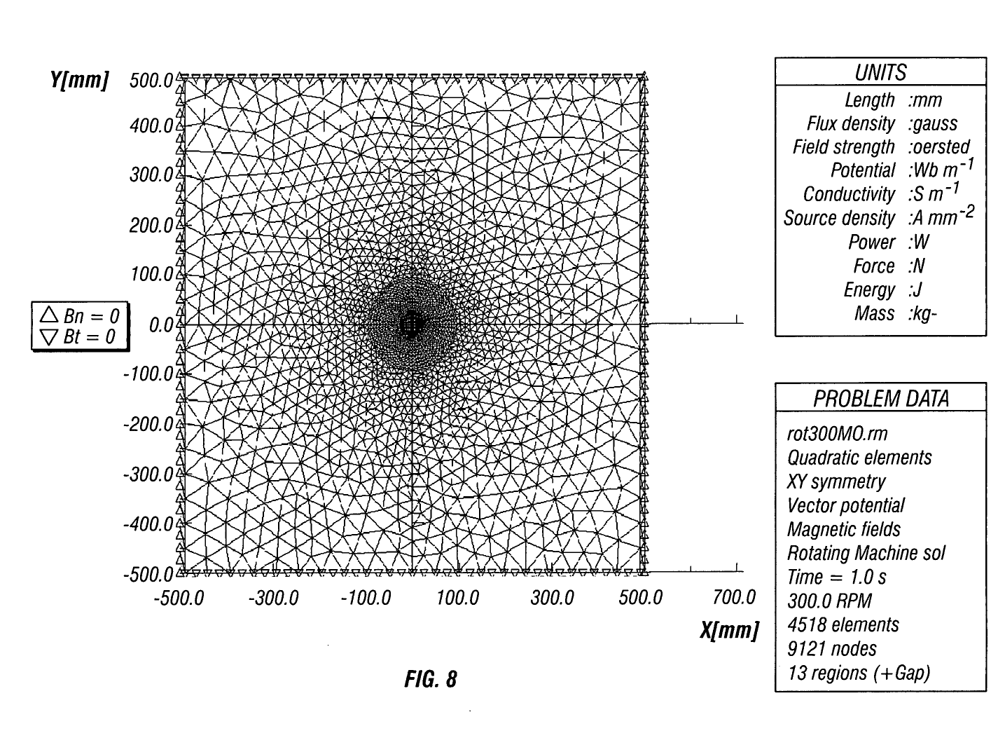

FIG. 6 shows magnetic field strength plotted against collar rpm. RPM is shown along the abscissa, and magnetic field strength is shown along the ordinate. The dashed line 601 indicates the responses predicted by Eq. (2). There is limited rpm resolution, particularly at the higher rotary speeds, because data were resampled to 100 samples per second, prior to processing in Excel. Thus, a rotary speed of 600 rpm represents 10 samples per rotation, and the next higher speed is 667 rpm, which corresponds to 9 samples per revolution. FIG. 6 shows a clear trend in which B_{xy} decreases monotonically with increasing rpm, so that B_{xy} measurements obtained at 500 rpm are about half of its original intensity. The wide spreads in B_{xy} at each speed result partly from speed variations within one rotation, and partly from limited rpm resolution. Eq. (2) appears to slightly over-estimate the effect of rotation.

It is important to note that the electrical conductivity of Aluminum (2.5E7 S/m) is about ten times greater than that of Monel (2.1E6 S/m). Thus the use of an Aluminum test collar provides an extreme case. In reality, the results shown for an Aluminum collar at 50 rpm might be typical of a Monel drill collar at 500 rpm. Thus, under field conditions with Monel collars, the B_{xy} field would lose about 5% of its original value by 500 rpm.

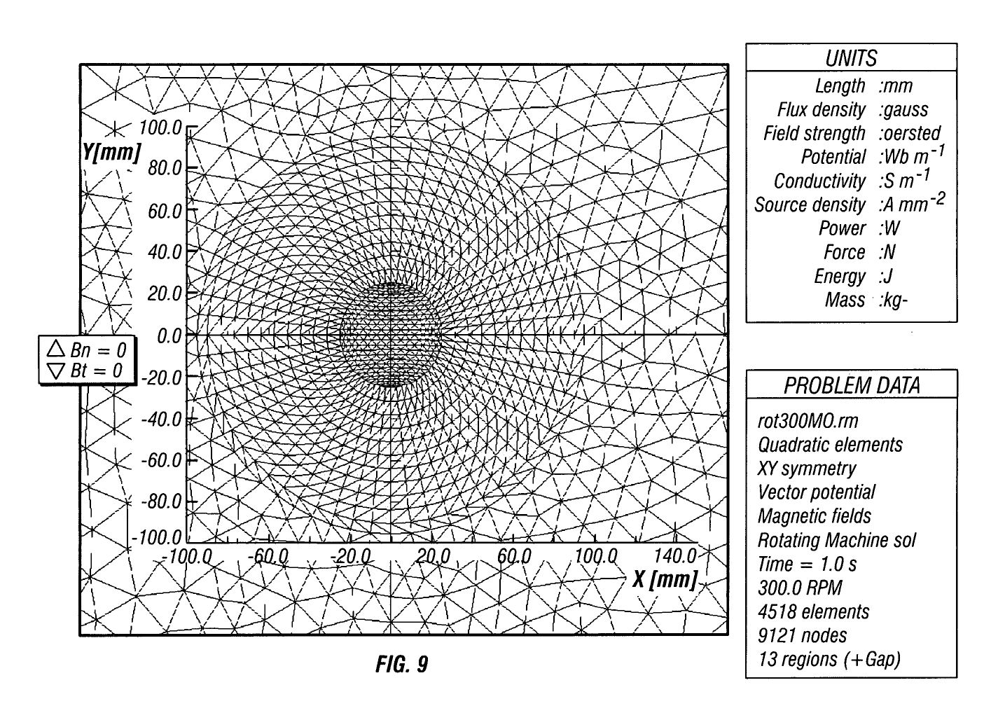

FIG. 7 shows magnetic toolface plotted against collar rpm. The relationship is monotonic and shows signs of flattening out above about 400 rpm. Eq. (1) is superimposed as a dashed line 701. Eq. (1) predicts a shift in toolface which is quite close to that which is observed. However, it is possible that even larger shifts might be observed with the magnetometer placed further inside the collar. For these tests, the magnet is placed within six inches of the end.

Because of the high conductivity of the Aluminum test collar, the results should again be modified for real-world conditions. With a Monel collar of similar dimensions, a toolface shift of about 5 degrees at 200 rpm is expected. This is a source of concern for rotating azimuth calculations which make use of the magnetic toolface.

Results using a stationary magnetometer inside a rotating Aluminum collar suggest that the rotation induces a toolface variation similar to that predicted by Eq. (1). The use of an Aluminum test collar permits experiments under extreme conditions. With Monel collars, the change in toolface caused by rotation is expected to be on the order of 5 degrees at 200 rpm for a 7″ by 2″ collar. A corresponding reduction is observed in the transverse field intensity.

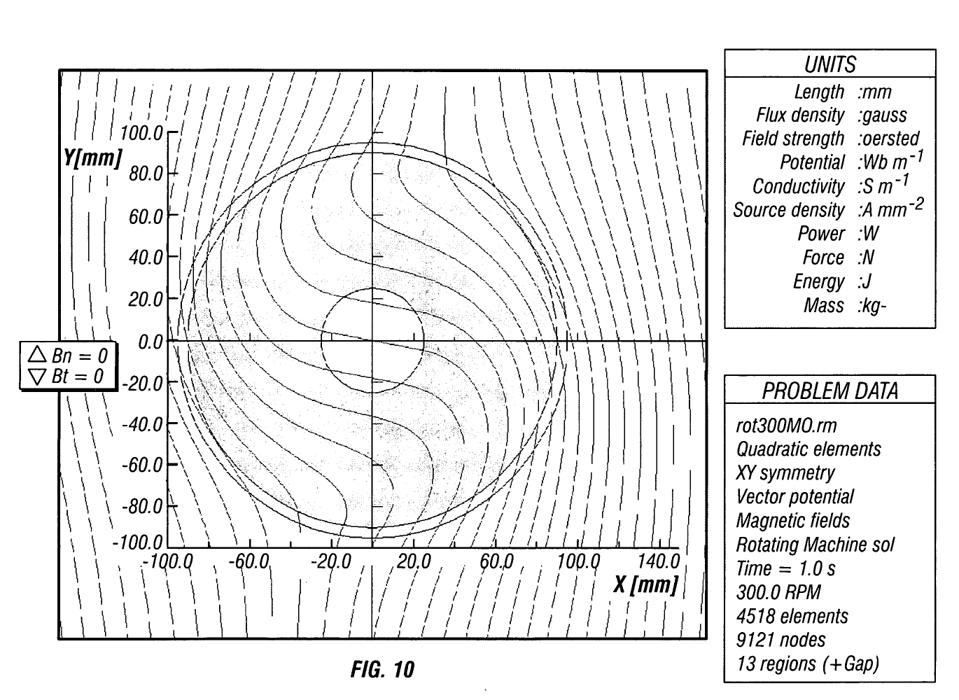

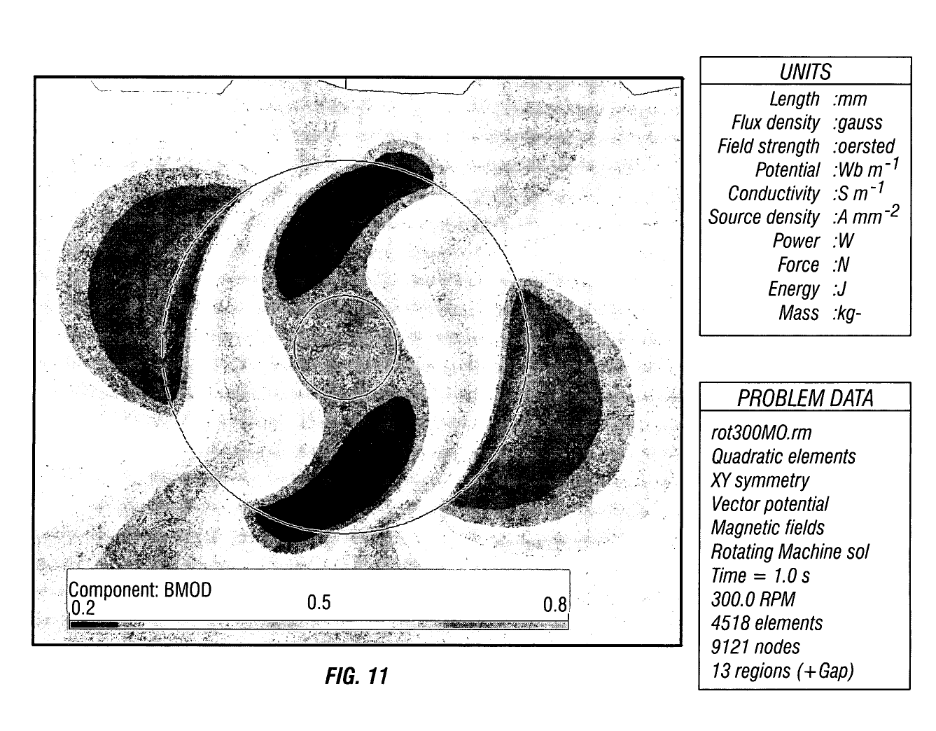

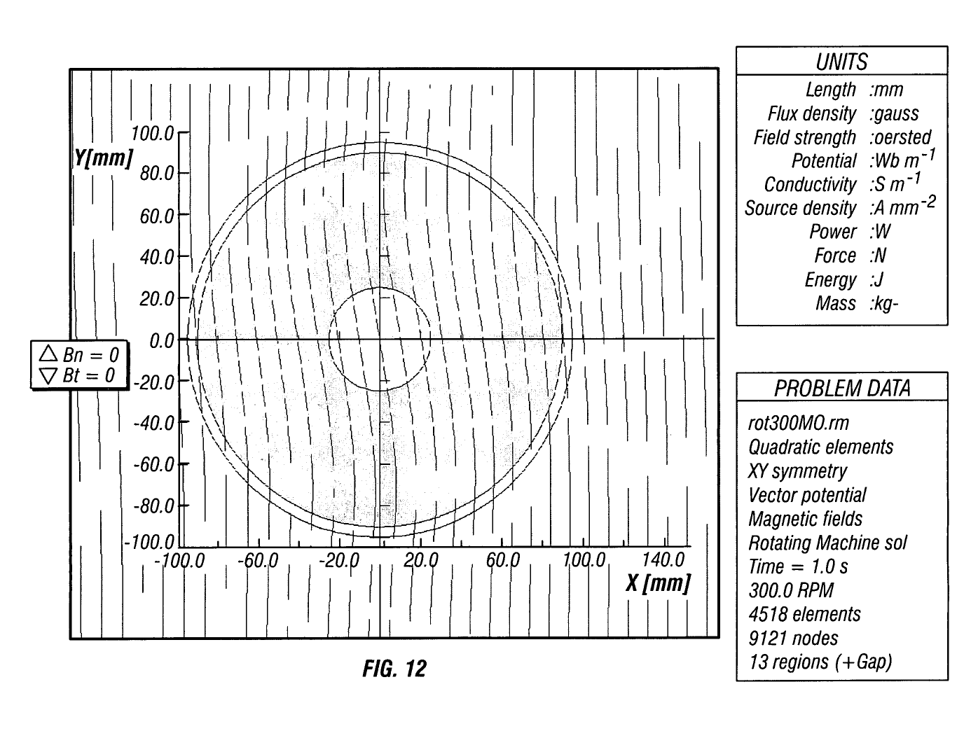

A model of the fields and eddy currents can be easily obtained using the Rotating Machines (RM) solver OPERA2d of Vector Fields Ltd. FIGS. 8-13 were obtained using the RM solver. The RM solver is a transient solver. Solutions are obtained as if the collar suddenly starts to rotate at time zero. Solutions can be obtained at any requested time. At very short times, the solution retains transient solutions, due to the self inductance of the eddy current loops. With an Aluminum collar and 300 rpm, the solution reaches steady state after about 0.5 s, while in a Monel collar, the equation reaches steady state after 0.1 s. FIGS. 8 and 9 show a stationary meshed FE model. All the solutions presented in FIGS. 10-13 are obtained at a time of 1 s so that in all cases the solution can be considered the steady state solution.

The background magnetic field (earth field) is generated by a cylinder shell (solenoid) with fixed current density. FIG. 8 shows a cross-section along the axis of the cylinder shell. In FIG. 8 the cylinder shell is situated at the left and right boundaries of the FE model. Boundary conditions are chosen so as to obtain a homogeneous field inside the cylinder, even with limited dimensions. The magnetic flux density B is orthogonal to the bottom and top boundaries and tangential to the right and left hand boundaries. The current density at the right and left boundaries are chosen to obtain a magnitude of magnetic field of B_{Yext}=0.50265 G, approximately equal to the magnitude of the earth's magnetic field.

In the centre of the FE model of FIG. 8 is a hollow metal cylinder, the drill collar. Electrical conductivities for Aluminum (σ=25 MS/m) and Monel (σ=2.1 MS/m) are used. The collar OD is 180 mm, and the collar ID is 50 mm. FIG. 9 is a closer look on the collar of the FE model of FIG. 8. Upon rotation, (FIGS. 10-13) the rotational frequency is 300 rpm.

In an exemplary embodiment of the invention, the rotating collar is a simple hollow cylinder. However, modeling any other (non-symmetric) cross-section of a rotating collar can also be performed without significant increase in time or effort. The longitudinal axis of the collar is oriented perpendicular to the direction of the magnetic field, so as to employ the two-dimensional FE model. However, it is easy to calculate for situations where this orthogonality does not exist. The axial field component does not contribute. So, where field and collar axis are not orthogonal, then just the reduced field component, orthogonal to the collar axis is used. No new model needs to be generated. All eddy currents are proportional to the orthogonal component of the earth's field.

Symmetry considerations for reducing the size of the FE model can not be used, since there are no possible boundaries through the center where the magnetic field is either orthogonal or tangential.

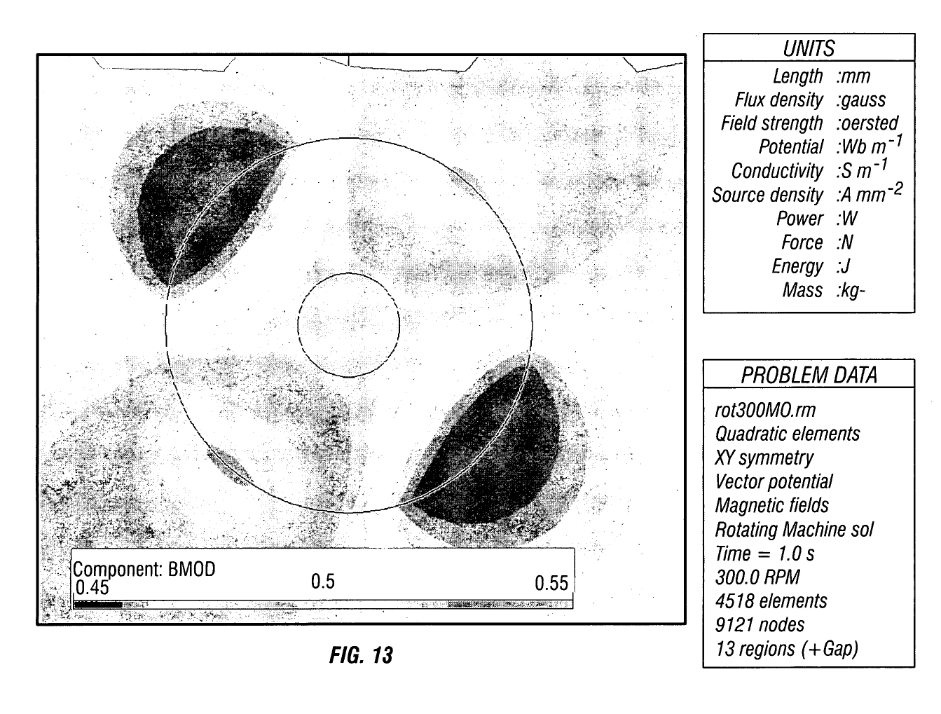

FIG. 10 shows field lines of an FE model using an Aluminum collar as rotation affects the magnetic field. A measurement of field direction and magnitude depends on the position inside the collar. FIG. 11 shows a contour plot of the magnitude of the flux density B, which ranges from 0.2 G to 0.8 G. |B| would be 0.50265 G everywhere without rotation.

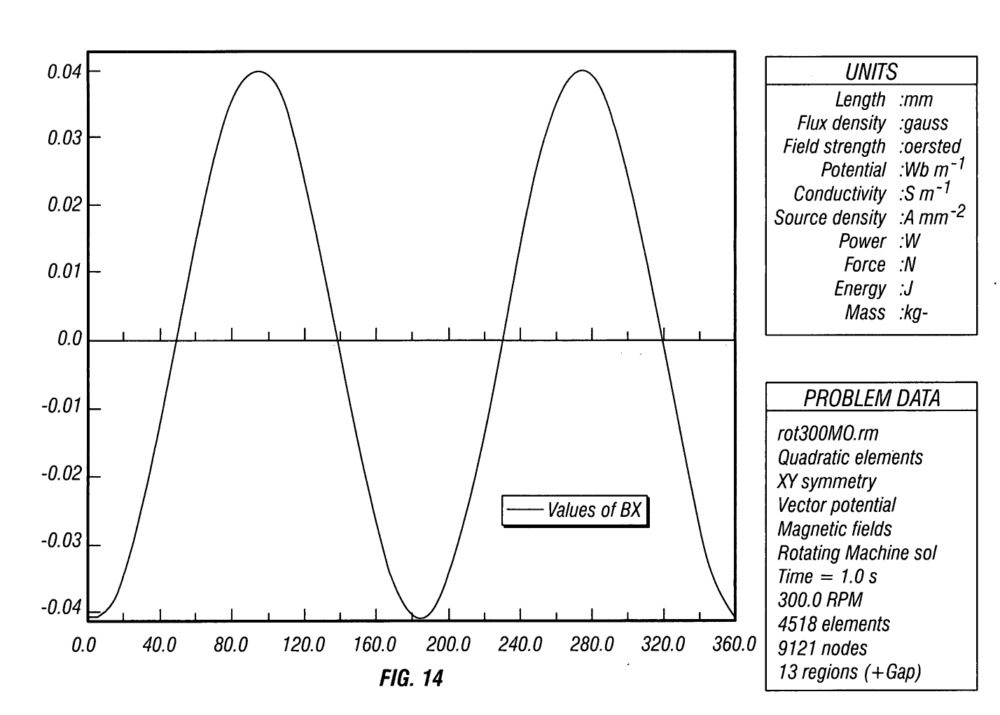

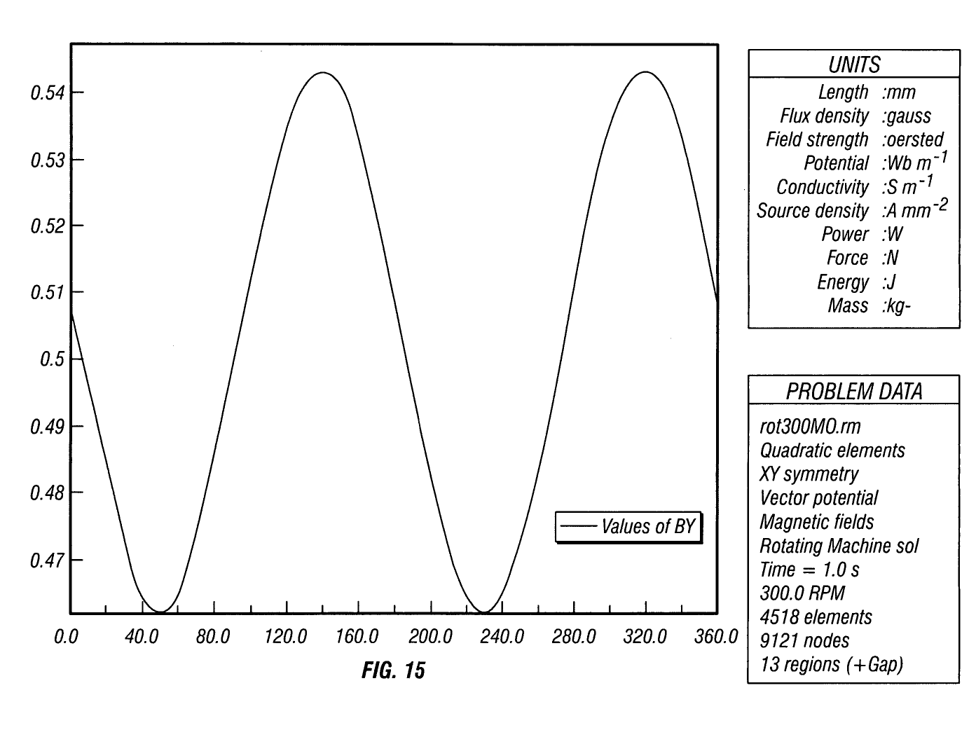

FIG. 12 shows field lines for a similarly rotating Monel collar. A measurement of field direction and magnitude depends on the position of the measurement device inside the collar. The angle of the field direction against the vertical is −8.8° measured at the center of the collar. On the circumference, the angle has both positive and negative deviations. FIG. 13 shows a contour plot of the magnitude of the flux density B for a Monel collar, |B| ranging from 0.45 G to 0.55 G.

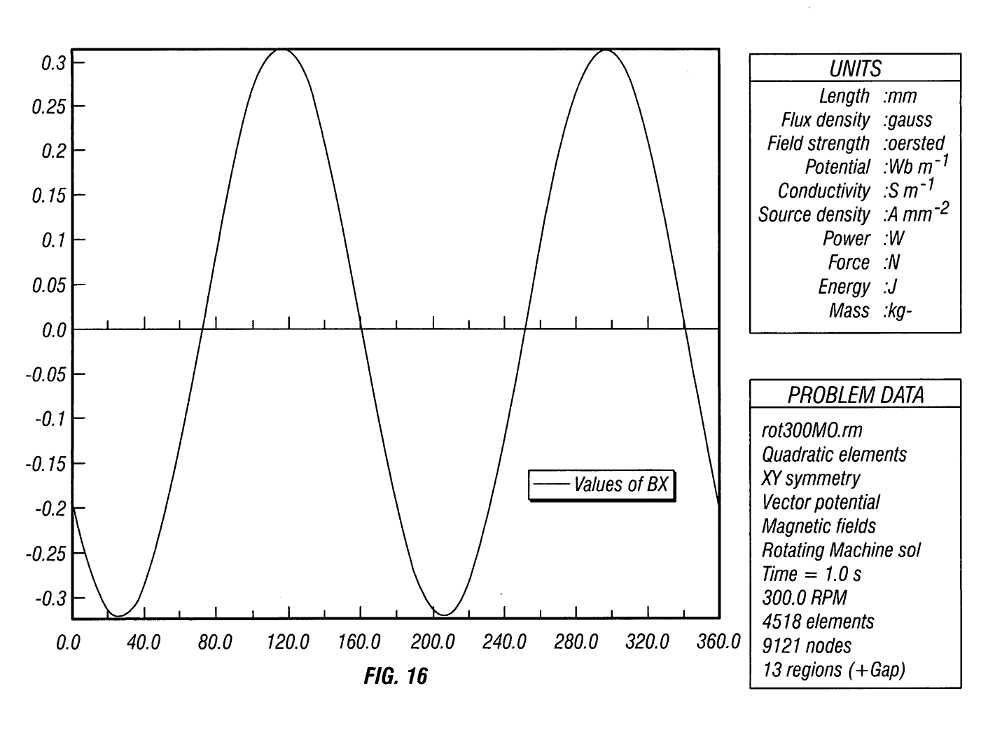

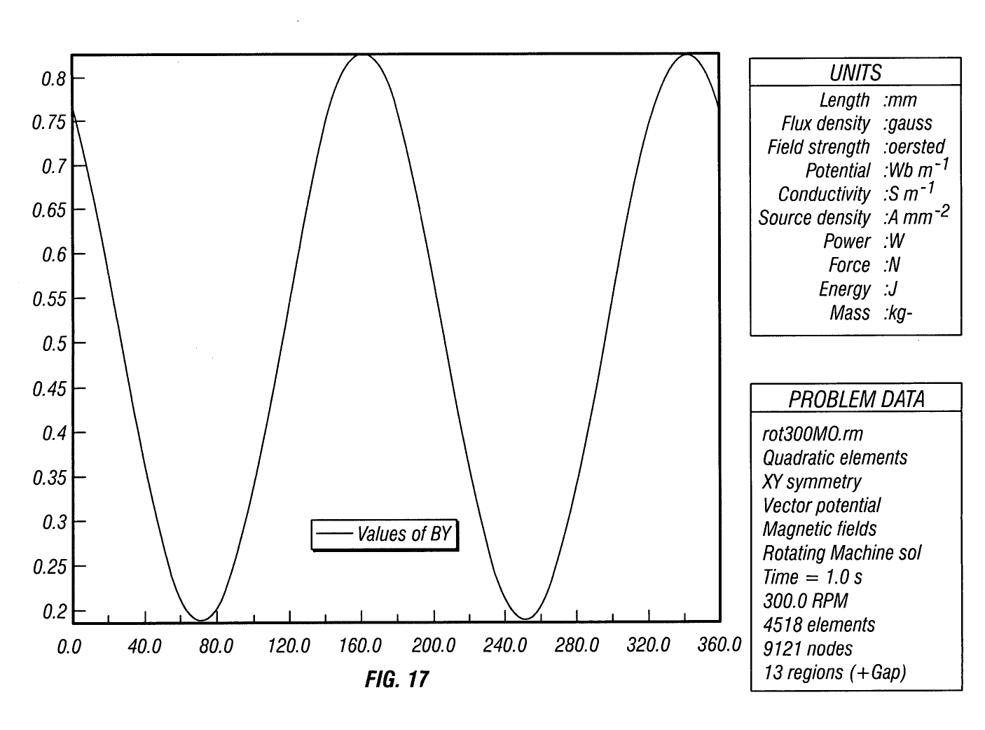

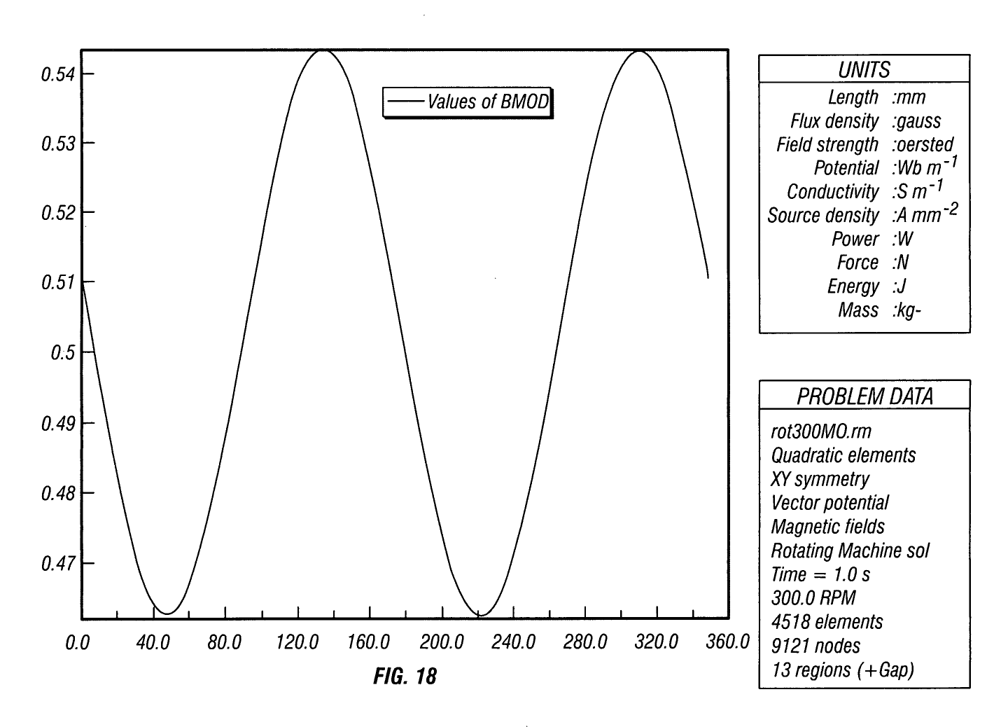

As expected, the direction of the magnetic field, as measured inside the rotating BHA, deviates from the direction of the true earth field. However, FIG. 12 reveals that around the circumference of the BHA, an average of this field deviation is zero. FIGS. 14 to 15 show plots of the Bₓ and B_{y} components at 300 rpm, respectively, at the circumference for the Monel collar. FIG. 18 shows the modulus of the magnetic flux along the circumference of the BHA at 300 rpm. FIGS. 16 and 17 show plots of the Bₓ and B_{y} components at 300 rpm, respectively, at the circumference for the Aluminum collar

From FIG. 14, one sees that the average of B_{X} is zero. Also, at the circumference of the BHA, the average flux density vector is equal to the applied external flux density vector (here B_{Yext}), see FIG. 18. For circles around the origin having a radius less than the BHA radius, the variation in Bₓ decreases but average Bₓ is no longer zero. For circles around the origin with radius greater than the BHA radius, the variation in Bₓ decreases and the average Bₓ is zero.

At the circumference of the BHA, the field components Bₓ and B_{y} of FIGS. 14-17 obey the relations:
Bₓ=−a*cos(2φ−ψ), (3)
and
B_{y}=B_{Yext}−a*sin(2φ−ψ) (4)
so that variation is dependent on 2φ and ψ, where φ is the angular distance around the circumference (magnetic tool face) and ψ is an offset angle that can be neglected for higher collar resistivity (Monel). However, this offset angle cannot be ignored for the Aluminum collar. Thus, if the x- and y-field components could be measured at two positions spaced 90° apart on the circumference of the BHA then the earth's field could be estimated accurately. Each component of the B field can be calculated by taking the average of the respective components of the two magnetometers spaced 90° apart. In the example, the average works out as below:
2B_{X}=−a cos(2φ−ψ)−a cos(2*(φ+90°)−ψ)=0, and (5)
2B_{Y}=B_{Yext}−a sin(2φ−ψ)+B_{Yext}−a sin(2*(φ+90°)−ψ)=2B_{Yext} (6)

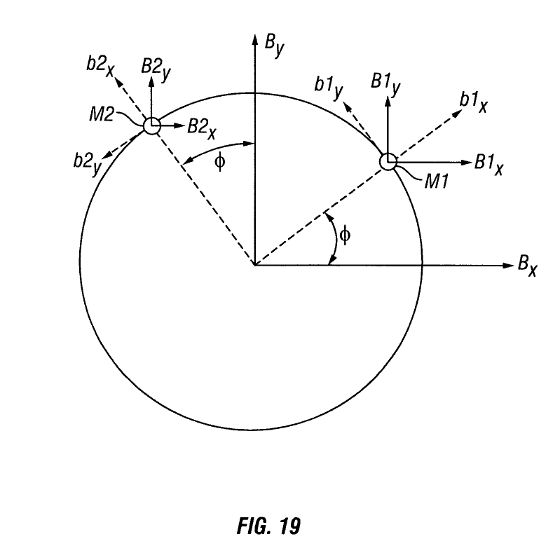

The problem, of course, is that we cannot measure the x- and y-components in the fixed earth coordinate reference frame. What we can measure is two components (e.g., the radial and circumferential components) at two different toolface angles. This is depicted in FIG. 19 where the x- and y-axes are as shown. There are two two-component magnetometers denoted by M1 and M2. Magnetometer M1 measures radial and circumferential components denoted by b1ₓ and b1_{y}, while magnetometer M2 measures radial and circumferential components denoted by b2ₓ and b2_{y}.
b1ₓ=B1ₓ cos(φ)+B1_{y} sin(φ)
b1_{y}=−B1ₓ sin(φ)+B1_{y} cos(φ)
b2ₓ=−B2ₓ sin(φ)+B2_{y} cos(φ)
b2_{y}=−B2ₓ cos(φ)−B2_{y} sin(φ) (7).
We also have from the finite element modeling:
B1ₓ=Bₓ−a cos(2φ−ψ)
B1_{y}=B_{y}−a sin(2φ−ψ)
B2ₓ=Bₓ+a cos(2φ−ψ)
B2_{y}=B_{y}+a sin(2φ−ψ) (8).

From equation (8) we get:
B1ₓ+B2ₓ=2Bₓ
B1_{y}+B2_{y}=2B_{y} (9)
Combining (9) with (7) gives
b1ₓ−b2_{y}=2Bₓ cos(φ)+2B_{y} sin(φ)
b1_{y}+b2ₓ=−2Bₓ sin(φ)+2B_{y} cos(φ) (10).
The terms on the left hand side of (10) are quantities that are measured using two two-component magnetometers on a rotating BHA.

For the determination of the magnetic tool face we have Bₓ equal zero and B_{y} equal B_{Yext}. Equations (10) simplify to:
b1ₓ−b2_{y}=2B_{Yext} sin(φ)
b1_{y}+b2ₓ=2B_{Yext} cos(φ) (11).
We obtain the tangent of the magnetic toolface by dividing the two equations by each other, hence:

$$tan ( ϕ ) = \frac{b {1}_{x} - b {2}_{y}}{b {1}_{y} + b {2}_{x}} . \qquad ( 12 )$$

From this equation the correct magnetic toolface φ can be obtained solely from the magnetometer measurements. No further knowledge is required.

If for some purpose the magnitude of the magnetic field component orthogonal to the tool axis is wanted it too can be calculated from the magnetometer measurements alone. By squaring both equations (11) and adding them (to make use of the identity sin²(φ)+cos²(φ)=1) we get:

$${B}_{Yext} = \frac{1}{2} \sqrt{{( b {1}_{x} - b {2}_{y} )}^{2} + {( b {1}_{y} + b {2}_{x} )}^{2}} . \qquad ( 13 )$$

If magnetometers cannot be mounted right onto the circumference, then they may experience a deviation of the field angle. This can be corrected using knowledge of the rotation speed and by finding a relationship between this speed and the angle deviation. The approximate values can be used to correct with a function depending on the rotational speed. Modeling results such as those shown above may be used, combined with a table lookup, to make the corrections in real time using a downhole processor.

It should be noted that the use of orthogonally mounted magnetometers is for exemplary purposes and is not to be construed as a limitation to the invention. It is sufficient for the purposes of the present invention to measure the magnetic field components in two directions other than 180° apart: using well known coordinate transformation methods, the method described above may be used. The method is applicable for determination of toolface angles for diverse applications including processing of measurements made by gamma ray tools, neutron-porosity tools, azimuthally sensitive resistivity tools, as well as for control of drilling direction.

Even if only one two-component magnetometer (M1 for example) is available we can determine the magnetic toolface angle φ. By substitution of equations (3) and (4) into the first two equations of the equation set (7) we get after some mathematical manipulation
b1ₓ=B_{Yext} sin(φ)−a cos(φ−ψ)
b1_{y}=B_{Yext} cos(φ)−a sin(φ−ψ) (14).
If B_{Yext} is known and ψ is zero (approximately true for Monel), we can eliminate the unknown variable “a” and obtain an equation for the unknown toolface φ:

$$tan ϕ = \frac{{B}_{Yext} cos ( ϕ ) - b {1}_{y}}{{B}_{Yext} sin ( ϕ ) - b {1}_{x}} . \qquad ( 15 )$$

Expressing the left hand side as sin(φ)/cos(φ), cross-multiplying, multiplying out and rearranging terms we get:
b1_{y} cos(φ)−b1ₓ sin(φ)=B_{Yext} cos² (φ)−B_{Yext} sin²(φ)=B_{Yext} cos(2φ) (16).
If the external field B_{Yext} is known, then (15) or (16) gives the solution for φ in terms of the two field components measured by a single magnetometer (here M1) on the collar. Possible ambiguities in the solution of (16) can be resolved by identifying the solution that results if the field distortion is neglected.

One method to determine B_{Yext} is from the total earth's magnetic field (a known quantity) at the wellbore location (its magnitude and inclination) and from a knowledge of the inclination and azimuth of the borehole. The inclination of the borehole and its azimuth are commonly obtained during drilling operations by carrying out a survey during cessation of drilling. Such surveys may be made using various combinations of gyroscopes, accelerometers and magnetometers. Alternatively, magnetometer measurements made when the drillstring is not rotating give a direct measurement of B_{Yext} at a survey point.

The processing of the data may be accomplished by a downhole processor. For the purposes of the present invention, a field programmable gate array is considered to be a processor. It should also be noted that a two-component magnetometer is intended to include to single component magnetometers. Implicit in the control and processing of the data is the use of a computer program implemented on a suitable machine readable medium that enables the processor to perform the control and processing. The machine readable medium may include ROMs, EPROMs, EAROMs, Flash Memories and Optical disks.

While the foregoing disclosure is directed to the specific embodiments of the invention, various modifications will be apparent to those skilled in the art. It is intended that all such variations within the scope and spirit of the appended claims be embraced by the foregoing disclosure.

Appendix

Eq. (1) for toolface shift can be derived by calculating eddy currents flowing along the axis of rotation. These in turn produce a transverse magnetic error field which is oriented perpendicular to the original transverse field component.

Let the drillstring be a cylinder with OD and ID equal to D and d respectively, surrounding a central magnetometer. The conductivity and magnetic permeability are σ and μ, the transverse component of the external field is Bxy, and the speed of rotation is angular velocity ω. A longitudinal filament of the drillstring is situated at radius r and toolface τ with respect to the external field. The cross-section of the filament is r·dr·d τ, and it crosses the transverse field with velocity ω·r·cos τ. An axial electric field is induced in the filament by this motion, given by
E=−B_{xy}·ωr·cos τ.
By Ohm's Law, this causes a current
I=−B_{xy}·σ·ω·r²·cos τ·dr·dτ.
The resulting magnetic flux at the center of the drillstring is
B=μ·I/(2·π·r), or B=−B_{xy}·σ·μ·ω/(2·π)·r·cos τ·dr·dτ.
This has components parallel and normal to the external transverse field. The resultant parallel component is
Bₚ=−B_{xy}·σ·μ·ω/(2·π)·r·sin τ·cos τ·dr·dτ,
and the normal component is
Bₙ=−B_{xy}·σ·μ·ω/(2·π)·r·cos²τ·dr·dτ.
Integrating over the drillstring cross-section, the effect parallel to the transverse field is
Bₚ=−B_{xy}·σ·μ·ω/(2·π)·∫₀^{2·π}∫_{d/2}^{D/2}r·cos²τ·dr·dτ,
and the effect normal to the transverse field is
Bₙ=−B_{xy}·σ·μ·ω/(2·π)·∫₀^{2·π}∫_{d/2}^{D/2}r·cos²τ·dr·dτ.
These integrals can be evaluated to give
Bₚ=0 and
Bₙ=−B_{xy}·σ·μ·ω·(D²−d²)/16.
If we write this as Bₙ=−x·B_{xy}, and assume that this secondary field and its own error fields are subject to similar perturbation, we find that with the external field now included
Bₚ=B_{xy}·(1−x²+x⁴−x⁶+ . . . )=B_{xy}/(1+x²)
Bₙ=B_{xy}·(−x+x³−x⁵+x⁷− . . . )=−B_{xy}·x/(1+x²)
The offset to phase angle is therefore
δφ=tan ⁻¹(Bₙ/Bₚ)=tan ⁻¹(−x)=tan ⁻¹[−σ·μ·ω·(D²−d²)/16],
and the apparent attenuation in B_{xy} is=1/√[1+tan²(δφ)]=cos(δφ).

What is claimed is:

1. A method of determining a toolface angle of a rotating bottom-hole assembly (BHA) in a borehole in an earth formation, rotation of the BHA producing a disturbance of a magnetic field in the earth formation, the method comprising:
(a) measuring two components of the earth's magnetic field at least one azimuthal position on the BHA during the rotation of the BHA; and
(b) estimating from the two components at the at least one azimuthal position a value of the toolface angle during the rotation of the BHA, the estimate substantially independent of the disturbance.

2. The method of claim 1 wherein the two components comprise a substantially radial component and a substantially transverse component.

3. The method of claim 1 wherein the at least one azimuthal position comprises at least two azimuthal positions that are substantially orthogonal to each other.

4. The method of claim 3 wherein estimating the value of the toolface angle further comprises using a relation of the form:
$$tan ( ϕ ) = \frac{b {1}_{x} - b {2}_{y}}{b {1}_{y} + b {2}_{x}}$$
where φ is the estimated tool face angle, b1 and b2 are the magnetic flux densities measured at the two positions and x and y refer to the radial and transverse components.

5. The method of claim 3 wherein the magnetometers are not on a circumference of the BHA, the method further comprising applying a correction based on a rotational speed of the BHA.

6. The method of claim 1 wherein the at least one azimuthal position comprises a single azimuthal position, and wherein estimating the toolface angle further comprises using an external flux density.

7. The method of claim 6 further comprising determining the external flux density from (i) the undisturbed earth's magnetic field at the borehole, (ii) an inclination of the borehole, and (iii) an azimuth of the borehole.

8. The method of claim 7 wherein the inclination and azimuth of the borehole are determined using at least one of (i) a magnetometer, (ii) an accelerometer, and (iii) a gyroscope.

9. An apparatus for determining a toolface angle of a rotating bottom-hole assembly (BHA) in a borehole in an earth formation, rotation of the BHA producing a disturbance of a magnetic field in the earth formation, the apparatus comprising:
(a) at least one magnetometer which measures two components of the earth's magnetic field at least one azimuthal position on the BHA during the rotation of the BHA; and
(b) a processor which estimates from the two components at the at least one azimuthal position a value of the toolface angle during the rotation of the BHA, the estimate substantially independent of the disturbance.

10. The apparatus of claim 9 wherein the two components comprise a substantially radial component and a substantially transverse component.

11. The apparatus of claim 9 wherein the at least one magnetometer comprises at least two magnetometers at azimuthal positions that are substantially orthogonal to each other.

12. The apparatus of claim 11 wherein the processor estimates the value of the toolface angle by further using a relation of the form:
$$tan ( ϕ ) = \frac{b {1}_{x} - b {2}_{y}}{b {1}_{y} + b {2}_{x}}$$
where φ is the estimated tool face angle, b1 and b2 are the magnetic flux densities measured at the two positions and x and y refer to the radial and transverse components.

13. The apparatus of claim 11 wherein the at least two magnetometers are not on a circumference of the BHA, and wherein the processor further applies a correction based on a rotational speed of the BHA.

14. The apparatus of claim 9 wherein the at least one magnetometer comprises a single magnetometer and wherein the processor estimates the toolface angle based at least in part by using an external flux density.

15. The apparatus of claim 14 wherein the processor determines the external flux density from (i) the earth's magnetic field at the borehole, (ii) an inclination of the borehole, and (iii) an azimuth of the borehole.

16. The apparatus of claim 14 further comprising at least one of (i) a magnetometer, (ii) an accelerometer, and (iii) a gyroscope which provide an output indicative of the inclination of the borehole and the azimuth of the borehole.

17. A computer readable medium for use with an apparatus for determining a toolface angle of a rotating bottom-hole assembly (BHA) in a borehole in an earth formation, rotation of the BHA producing a disturbance of a magnetic field in the earth formation, the apparatus comprising:
(a) at least one magnetometer which measures two components of the earth's magnetic field at least one azimuthal position on the BHA during the rotation of the BHA;
the medium including instructions that enable a processor to
(b) estimate from the two components at the at least one azimuthal position a value of the toolface angle during the rotation of the BHA, the estimate substantially independent of the disturbance.

18. The medium of claim 17 further comprising at least one of (i) a ROM, (ii) an EPROM, (iii) an EAROM, (iv) a flash memory, and (v) an optical disk.
